(19) United States
(12) Patent Application Publication
(10) Pub. No.: US 2010/0139495 A1
(43) Pub. Date: Jun. 10, 2010

(54) Valve for Cappuccino Maker

(75) Inventor: Francesco Ranzoni, Brescia (IT)

Correspondence Address: SHOEMAKER AND MATTARE, LTD, 10 POST OFFICE ROAD - SUITE 100, SILVER SPRING, MD, 20910, US

(73) Assignee: BIALETTI INDUSTRIE S.P.A., Coccaglio, Brescia (IT)

(21) Appl. No.: 12/438,919

(22) PCT Filed: Jul. 24, 2006
(86) PCT No.: PCT/IT2006/000562

§ 371 Date: Dec. 2, 2009

(51) Int. Cl. A47J 31/42; F16K 31/12; F16K 35/00

(52) U.S. Cl. 99/302 R; 251/59; 251/89

(57) ABSTRACT

The present invention concerns a valve for a home cappuccino maker of the type comprising a boiler and a collector having a column. The valve comprises a valve body, coupling means suitable for fixing the valve to coupling means of the column, and a shutter mobile between a closed position and an open position of a duct. The valve also comprises a basket suitable for cooperating with the coupling means of the column and with the shutter.

### BACKGROUND OF THE INVENTION

The object of the present invention is an improved valve for use on apparatuses for the preparation of hot drinks, in particular for the preparation of cappuccinos or similar.

Here and hereafter, by the term “cappuccino maker” we mean any apparatus for the preparation at home of hot drinks, in particular for the preparation of coffee, cappuccinos, white coffee or other brews obtained from coffee or barley powder or similar.

In cappuccino makers valve systems are used that allow pressurised coffee brew to be dispensed through a predetermined amount of milk.

Some valves suitable for this purpose are described in publications WO 2006/008763, WO 2006/008764 and WO 2006/008768, in the name of the same Applicant.

Known cappuccino makers, whilst being highly appreciated and widely used, are not without defects.

The coupling between cappuccino makers and known valves may not be very safe if the apparatus is used distractedly, inaccurately and not in accordance with the manufacturer's instructions.

### OBJECT AND SUMMARY OF THE INVENTION

The purpose of present invention is to devise and provide an improvement of the known valve for cappuccino makers that allows the aforementioned drawbacks with reference to the prior art to be at least partially avoided.

In particular, the task of the present invention is to provide a valve system that ensures greater safety of use even if it is used distractedly, inaccurately and not in accordance with the manufacturer's instructions.

This purpose and this task are accomplished through a valve in accordance with claim 1.

### BRIEF DESCRIPTION OF THE DRAWINGS

Further characteristics and advantages of the valve according to the invention shall become clearer from the following description of preferred example embodiments, given for indicating and not limiting purposes, with reference to the attached figures, in which:

FIG. 1 schematically illustrates the side elevation view of a cappuccino maker;

FIG. 2 schematically illustrates a section along the line II-II of a detail of the cappuccino maker of FIG. 1 with a known valve in a first configuration;

FIG. 3 schematically illustrates the section along the line III-III of FIG. 2;

FIG. 4 schematically illustrates a section similar to that of FIG. 2 in a second configuration;

FIG. 5 schematically illustrates the section along the line V-V of FIG. 4;

FIG. 6 schematically illustrates a section similar to that of FIG. 4 in a third configuration;

FIG. 7 schematically illustrates the section along the line VII-VII of FIG. 6;

FIG. 8 schematically illustrates a section similar to that of FIG. 6 in a fourth configuration;

FIG. 9 schematically illustrates the section along the line IX-IX of FIG. 8;

FIG. 10 schematically illustrates a section along the line II-II of a detail of the cappuccino maker of FIG. 1 with a valve according to the invention in a first configuration;

FIG. 11 schematically illustrates the section along the line XI-XI of FIG. 10;

FIG. 12 schematically illustrates a section similar to that of FIG. 10 in a second configuration;

FIG. 13 schematically illustrates the section along the line XIII-XIII of FIG. 12;

FIG. 14 schematically illustrates a section similar to that of FIG. 12 in a third configuration;

FIG. 15 schematically illustrates the section along the line XV-XV of FIG. 14.

### DETAILED DESCRIPTION OF THE PREFERRED EMBODIMENTS

Hereafter the meanings of the expressions “upper” and “lower” or “high” and “low” or even “over” and “under” or similar, refer to the cappuccino maker in its normal working position. The normal working position is that which allows the cappuccino maker to be stably placed on a stove in order to prepare a cappuccino.

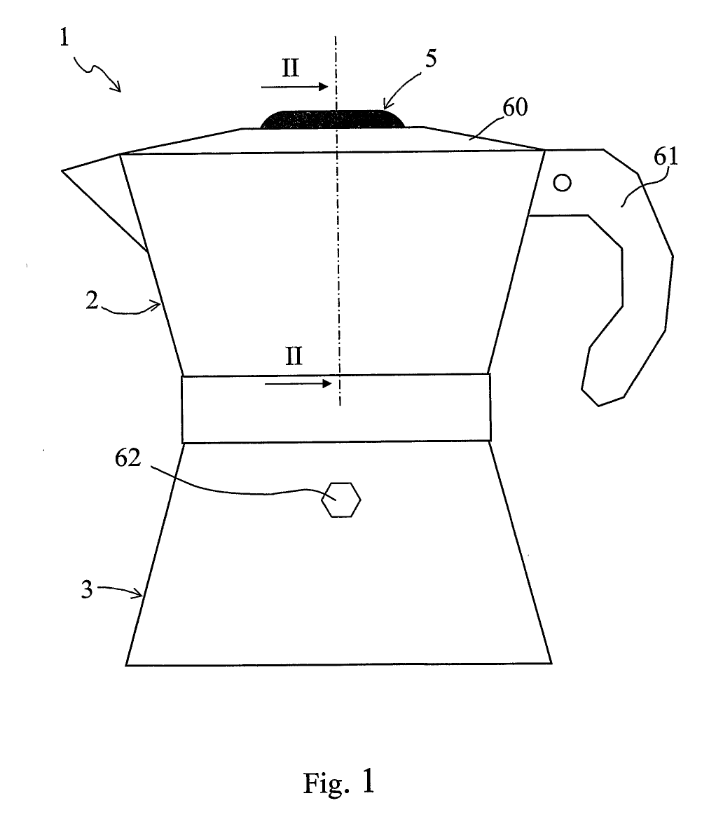

With reference to FIG. 1, a cappuccino maker has been wholly indicated with 1. The cappuccino maker 1 comprises, in a per se known way, a collector 2 and a boiler 3. The cappuccino maker also comprises a duct 4 that places the boiler 3 in communication with the collector 2 and a valve 5′ that regulates the dispensing of the coffee brew.

The cappuccino maker 1, in order to work correctly and safely so that it is comfortable for the user, must also comprise other elements. Some can be seen in FIG. 1: a lid 60, a handle 61 and a safety valve 62. Others are not represented: a funnel, a filter and a gasket. However, such elements are irrelevant for the purposes of the present invention and therefore shall not be considered hereafter.

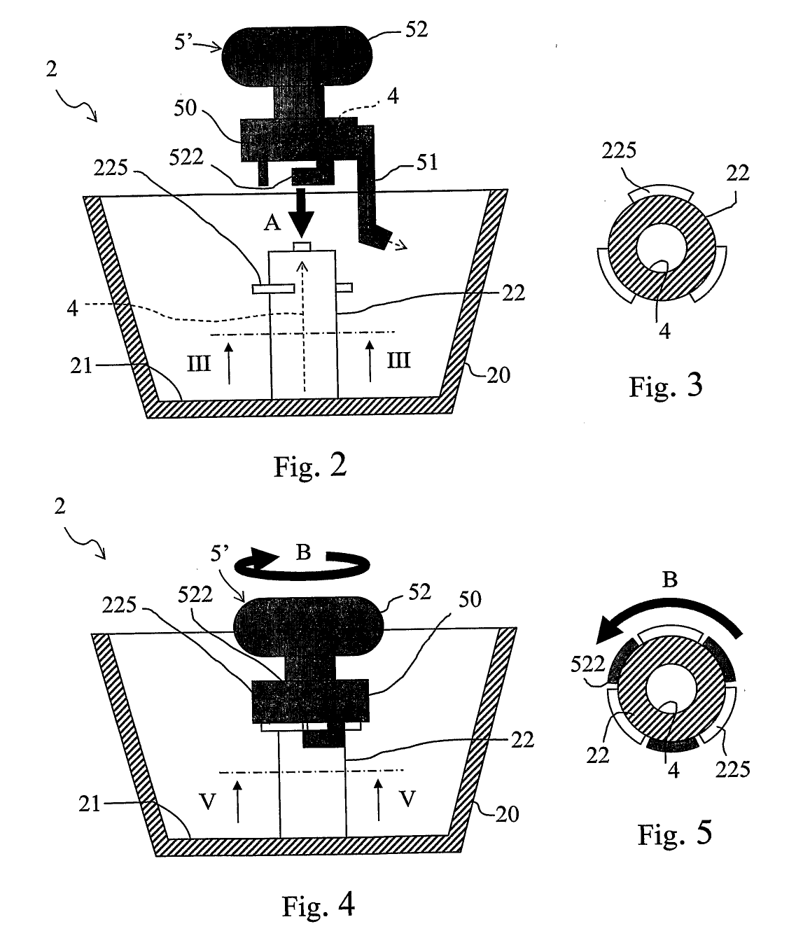

In accordance with the schematic view of the detail of FIG. 2, the collector 2 comprises side walls 20, a base 21 on which a column 22 is fitted.

The valve 5′ comprises a valve body 50, an auxiliary duct 51 and a shutter 52. The shutter 52 is mobile between a position closing the duct 4 and a position opening the duct 4. The movement of the shutter from the closed position to the open position is controlled by the pressure inside the boiler 3.

The operation of some possible embodiments of the valve 5′ is described in detail in publications WO 2006/008763, WO 2006/008764 and WO 2006/008768 in the name of the same Applicant.

For the purposes of understanding the present invention, the following outline description is sufficient.

When the cappuccino maker 1 is ready for operation, it contains a predetermined amount of water in the boiler 3, a predetermined amount of coffee powder in the funnel and a predetermined amount of milk in the collector 2. The valve 5′ is loaded, i.e. it has the shutter lowered in closed position so as to close the duct 4.

When heat is supplied to the boiler 3, the pressure inside of it increases up to the limit value at which the shutter 52 passes to the open position and the valve 5′ lets the coffee brew run out into the milk. Due to the pressure with which the coffee is injected into the milk, the characteristic froth of the cappuccino is formed.

In FIG. 2 the dispensing path 4 of the coffee is schematised with a broken line. In the following figures the auxiliary duct 51 has been removed for greater clarity.

The column 22 and the valve body 50 comprise matching coupling means, respectively indicated with 225 and 522.

In accordance with the embodiments schematised in the attached figures, the coupling means comprise a bayonet coupling. In particular, the column 22 comprises a plurality of tabs 225, whereas the valve body 50 comprises a plurality of L-shaped stops 522.

In accordance with FIGS. 2 to 9 different operating configurations of the cappuccino maker 1 and of the relative known valve 5′ shall be described hereafter.

In FIG. 2 the dismounted configuration is schematised in which the valve 5′ has been removed, for example for washing. In order to replace the valve 5′ in working configurations, it is necessary to place it over the column 22 and couple it along the direction indicated by the arrow A.

The movement described above takes the valve 5′ into the transitional configuration schematised in FIGS. 4 and 5. The L-shaped stops 522 are placed between the tabs 225, without however fixing the valve 5′ to the column 22. In particular, the valve 5′ is free to lift along the axis of the column 22. In order to couple the valve 5′ with the column 22 it is necessary to rotate it in the direction indicated by the arrow B.

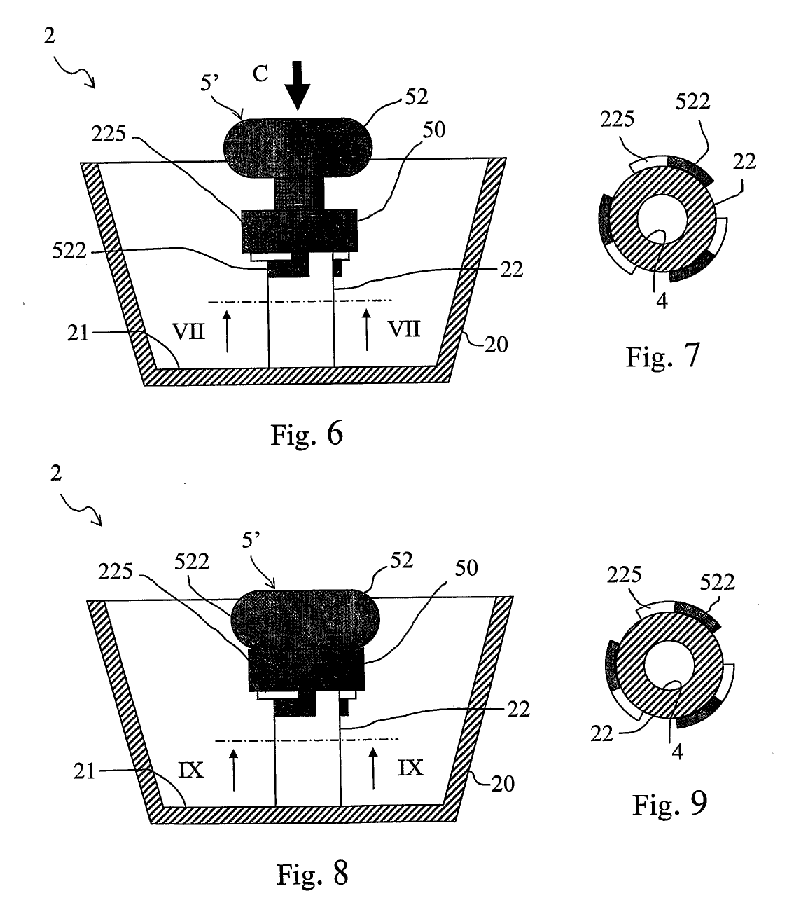

The movement described above takes the valve 5′ into the open configuration schematised in FIGS. 6 and 7. The L-shaped stops 522 lock onto the tabs 225, fixing the valve 5′ to the column 22. In particular, the valve 5′ is fixed along the axis of the column 22. In order to load the valve 5′ it is necessary to lower the shutter 52 along the direction indicated by the arrow C, to the closed position.

The movement described above takes the valve 5′ into the loaded configuration schematised in FIG. 8.

The valve 5′ is fixed to the column 22 and closes the duct 4 allowing the formation of pressure inside the boiler 3.

During the operation of the cappuccino maker 1, the pressure of the steam in the boiler 3 lifts the shutter 52 and takes the valve 5′ back from the loaded configuration of FIG. 8 to the open configuration of FIG. 6. In this way the pressurised coffee flows into the milk producing the characteristic froth of the cappuccino.

From the description shown above of the operation of the known valve 5′, the man skilled in the art shall understand how careless use of the cappuccino maker can be not entirely safe.

Indeed, in the transitory configuration of FIG. 4 it is however possible to load the valve 5′ even if it is not correctly fixed to the column 22. In this way it is thus possible to close the duct 4 and allow the formation of pressure inside the boiler 3.

In such a condition, once a predetermined pressure level has been achieved in the boiler 3, instead of the shutter 52 lifting in a controlled manner, the entire valve 5′ could lift in an uncontrolled manner.

Similarly, from the loaded configuration of FIG. 8 it is possible to rotate the valve body 50 in the opposite direction to the arrow B. In this way the decoupling of the bayonet coupling is obtained, irrespective of the residual pressure level present inside the boiler 3.

If, for whatever reason, the residual pressure present inside the boiler 3 is greater than the external pressure, the decoupling of the bayonet coupling can determine the uncontrolled lifting of the valve 5′ and/or the escape of steam from the column 22.

The valve 5 in accordance with the present invention proposes to prevent the possible circumstances outlined above.

The valve 5 in accordance with the invention comprises:
a valve body 50;
coupling means 522 suitable for fixing the valve 5 to the coupling means 225 of a column 22 of a cappuccino maker 1;
a shutter 52 mobile between an open position and a closed position; and
a basket 55 suitable for cooperating with the coupling means 225 of the column 22 and with the shutter 52.

In accordance with a preferred embodiment, the basket 55 comprises a flange 550 from which project feet 551. The basket 55 is free to slide along the valve body 50. Moreover, the basket 55 is fixed so that there cannot be any relative rotation with respect to the valve body 50.

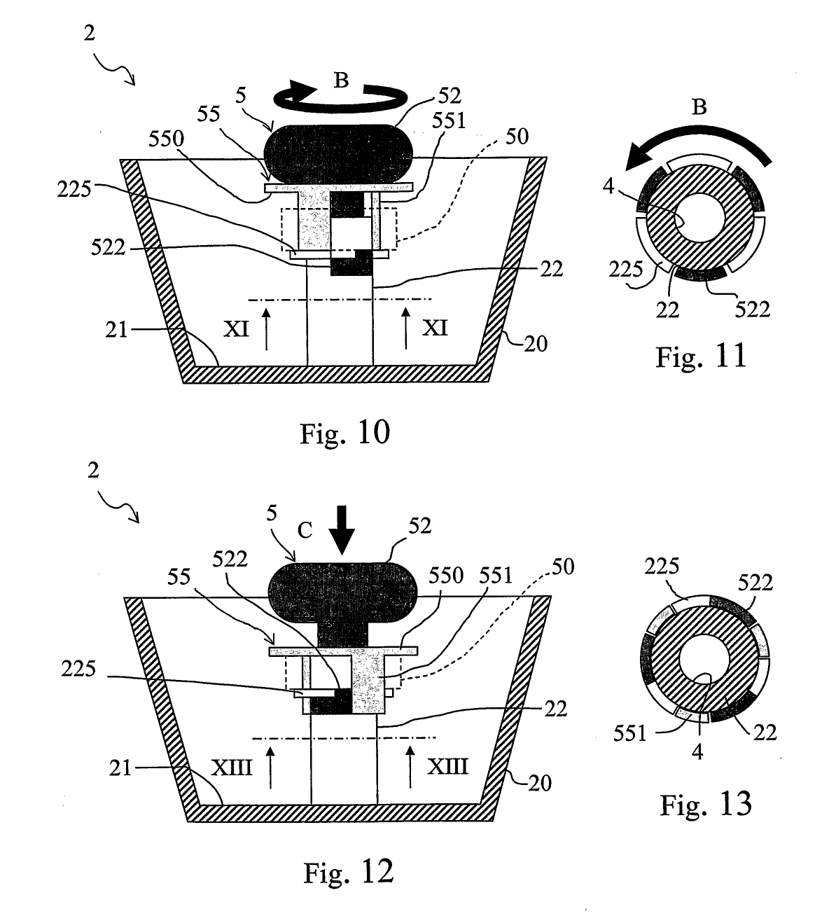

With reference to FIGS. 10, 12 and 14, the operation of the valve 5 according to the invention shall be described hereafter. In such figures, the valve body has been shown transparent for the sake of greater clarity.

FIG. 10 schematically illustrates the transitional configuration of the valve 5, similar to the one represented in FIG. 4 for the known valve 5′. The L-shaped stops 522 are arranged between the tabs 225, without however fixing the valve 5 to the column 22. In such a transitional configuration the feet 551 of the basket 55 rest upon the tabs 225 of the column 22, whereas the flange 550 remains in contact with the mobile shutter 52. In other words, the basket 55 imposes a minimum distance between the mobile shutter 52 and the tabs 225 of the column 22.

The rotation of the valve body 50 in direction B fixes the valve 5 to the column 22 and takes it into the open configuration schematised in FIGS. 12 and 13. The L-shaped stops 522 lock onto the tabs 225, fixing the valve 5 to the column 22. Moreover, when there is no longer contact between the feet 551 of the basket 55 and the tabs 225, the basket is free to descend into the position clearly visible in FIG. 12. In such a configuration, the feet 551 insert into the spaces left free between the L-shaped stops 522 and the tabs 225 (see FIG. 13, if necessary comparing it with FIG. 7 for greater clarity).

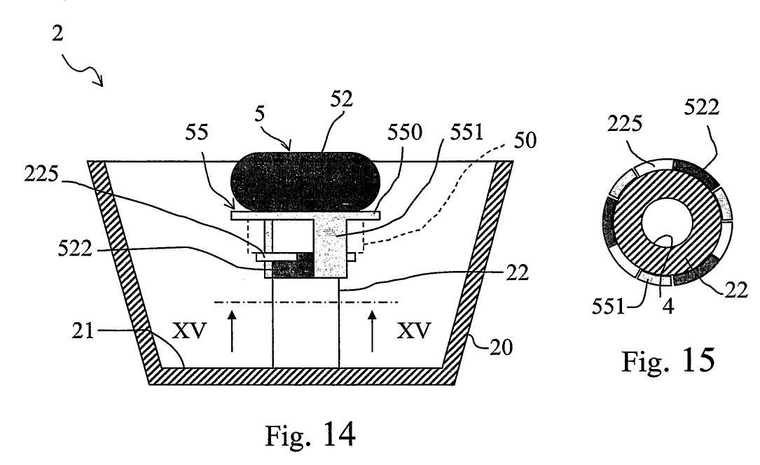

By pressing the shutter 52 in the direction of arrow C, the valve 5 is taken into the loaded configuration schematised in FIG. 14. The valve 5 is fixed to the column 22 and closes the duct 4 allowing the formation of pressure inside the boiler 3.

The operation of the valve 5 according to the invention is similar to that described above with reference to the known valve 5′. The pressure in the boiler 3 takes the shutter 52 from the closed position to the open position; in other words it takes the valve 5 from the loaded configuration of FIG. 14 to the open configuration of FIG. 12. In this way the pressurised coffee flows into the milk producing the characteristic froth of a cappuccino.

From everything that has been described above, it shall be clear to the man skilled in the art how the basket 55 is suitable for placing the mobility of the shutter 52 in relation with the position of the coupling means 522 of the valve 5 with respect to the coupling means 225 of the column 22.

At the same time, the basket 55 is suitable for placing the mobility of the coupling means 522 of the valve 5 with respect to the coupling means 225 of the column 22 in relation with the position of the shutter 52.

In particular, in the transitional configuration of FIG. 10 it is impossible to lower the shutter 52 and load the valve 5 since it is not correctly fixed to the column 22. The basket 55, going between the tabs 225 and the shutter 52, prevents the latter from being able to be moved into closed position.

In this way it is therefore impossible for pressure to form inside the boiler 3 with the valve 5 not correctly fixed. This avoids reaching a pressure level in the boiler 3 being reached that can lift the valve 5 in an uncontrolled manner.

Similarly, from the loaded configuration of FIG. 14 it is impossible to rotate the valve body 50 in the opposite direction to the arrow B so as to detach the valve 5 from the column 22. The feet 551 of the basket, going between the tabs 225 and the L-shaped stops 522, prevent the decoupling of the bayonet coupling. The decoupling can only occur after having lifted the basket 55 and with it the shutter 52, thus opening the duct 4.

If, for whatever reason, the residual pressure present inside the boiler 3 is greater than the external pressure, the lifting of the shutter 52 determines the venting of the pressure through the auxiliary duct 51 before the decoupling of the bayonet coupling.

From what has been described above, it shall be clear to the man skilled in the art how the cappuccino maker 1 equipped with the valve 5 according to the invention does not suffer from the drawbacks trouble known cappuccino makers.

A man skilled in the art can make modifications and adaptations to the embodiments of the valve and of the cappuccino maker described above and can replace elements with functionally equivalent elements, in order to satisfy contingent requirements, without departing from the scope of the following claims.

1-11. (canceled)

12. Valve for a home cappuccino maker of the type comprising a boiler and a collector having a column, said valve comprising:
a valve body;
coupling means suitable for fixing the valve to coupling means of said column;
a shutter mobile between a closed position and an open position of a duct; and
a basket suitable for cooperating with the coupling means of the column and with the shutter.

13. Valve according to claim 12, in which said basket is suitable for placing the mobility of the shutter in relation with the position of the coupling means of the valve with respect to the coupling means of the column.

14. Valve according to claim 12, in which said basket is suitable for placing the mobility of the coupling means of the valve with respect to the coupling means of the column in relation with the position of the shutter.

15. Valve according to claim 12, in which said basket is free to slide along the valve body and is fixed so that there can be no rotation of the basket with respect to the valve body.

16. Valve according to claim 12, in which said basket comprises a flange from which project feet.

17. Valve according to claim 16, in which said flange is suitable for resting upon said shutter.

18. Valve according to claim 12, in which the coupling means of the valve comprise L-shaped stops.

19. Valve according to claim 12, in which the coupling means of the column comprise tabs.

20. Valve according to claim 19, in which said feet are suitable for resting upon said tabs of said column so as to prevent the mobility of said shutter.

21. Valve according to claim 19, in which said feet are suitable for going between the L-shaped stops of the valve and the tabs of the column so as to prevent their relative mobility.

22. Cappuccino maker comprising a valve according to claim 12.
